(19) United States
(12) Patent Application Publication
(10) Pub. No.: US 2010/0154948 A1
(43) Pub. Date: Jun. 24, 2010

(54) TIRE TREAD WITH GROOVE REINFORCEMENT

(75) Inventors: Johan Peter Dahlberg, Luxembourg (LU); Stephane Jose Geelen, Chaudfontaine (BE); Annette Lechtenboehmer, Ettelbruck (LU); Filomeno Gennaro Corvasce, Mertzig (LU); Matthieu Pingenat, Hettange Grande (FR); Pierre Bernard Raoul Brochet, Luxembourg (LU); Anne Therese Peronnet-Paquin, Luxembourg (LU); Jacek Wojcik, Colmar-Berg (LU); Jean Luc Dheur, Arlon (BE); Isabelle Lea Louise Marie Lambert, Arion (BE)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(73) Assignee: Goodyear Tire & Rubber Company, Akron, OH (US)

(21) Appl. No.: 12/340,780

(22) Filed: Dec. 22, 2008

(51) Int. Cl. B60C 11/00

(52) U.S. Cl. 152/209.4

(57) ABSTRACT

A tire has an axis of rotation. The tire includes two sidewalls extending radially outward and a tread disposed radially outward of the two sidewalls and interconnecting the two sidewalls. The tread includes a main portion comprising a first compound and a reinforcing structure comprising a second compound having reinforcing short fibers oriented between −20 degrees to +20 degrees to a circumferential direction of the tread. The main portion of the tread includes at least one circumferential groove separating circumferential ribs. Each circumferential groove has two sides and a base therebetween. The reinforcing structure includes a layer of the second compound secured to the sides of each circumferential groove.

### FIELD OF THE INVENTION

The present invention relates to a tire, and more particularly, to a tire tread with groove reinforcement.

### BACKGROUND OF THE INVENTION

A pneumatic tire typically includes a pair of axially separated inextensible beads. A circumferentially disposed bead filler apex extends radially outward from each respective bead. At least one carcass ply extends between the two beads. The carcass ply has axially opposite end portions, each of which is turned up around a respective bead and secured thereto. Tread rubber and sidewall rubber are located axially and radially outward, respectively, of the carcass ply.

The bead area is one part of the tire that contributes a substantial amount to the rolling resistance of the tire, due to cyclical flexure which also leads to heat buildup. Under conditions of severe operation, as with runflat and high performance tires, the flexure and heating in the bead region can be especially problematic, leading to separation of mutually adjacent components that have disparate properties, such as the respective moduli of elasticity. In particular, the ply turnup ends may be prone to separation from adjacent structural elements of the tire.

The tire tread is another part of the tire that contributes a substantial amount to the rolling resistance of the tire. Tread groove deformation may lead to subsequent heat buildup in the tread compound during operation of the tire, and vice versa, thereby increasing rolling resistance.

### SUMMARY OF THE INVENTION

A tire in accordance with the present in invention has an axis of rotation. The tire includes two sidewalls extending radially outward and a tread disposed radially outward of the two sidewalls and interconnecting the two sidewalls. The tread includes a main portion comprising a first compound and a reinforcing structure comprising a second compound having reinforcing short fibers oriented between −20 degrees to +20 degrees to a circumferential direction of the tread. The main portion of the tread includes at least one circumferential groove separating circumferential ribs. Each circumferential groove has two sides and a base therebetween. The reinforcing structure includes a layer of the second compound secured to the sides of each circumferential groove.

In another aspect of the present invention, the tire is a pneumatic tire.

In still another aspect of the present invention, the tire is a non-pneumatic tire.

In yet another aspect of the present invention, the tire further includes a carcass ply radially inward of the tread.

In still another aspect of the present invention, the base and the two sides of the at least one circumferential groove define a U-shape.

In yet another aspect of the present invention, the reinforcing structure is secured to the sides and the base of the at least one circumferential groove to define a U-shaped reinforcing structure.

In still another aspect of the present invention, the layer has a thickness between 0.5 mm and 1.5 mm.

In yet another aspect of the present invention, the short fibers of the reinforcing structure are aramid short fibers.

In still another aspect of the present invention, the short fibers of the second compound have lengths ranging from 0.5 mm to 10 mm and thicknesses ranging from 5 microns to 30 microns.

In yet another aspect of the present invention, the reinforcing structure comprises a pair of separate structures secured to only the sides of the at least one circumferential groove.

In still another aspect of the present invention, the reinforcing structure extends radially outward to a ground-contacting surface of the tread.

In yet another aspect of the present invention, the second compound is stiffer than the first compound.

In still another aspect of the present invention, the second compound is stiffer in a circumferential direction than in the radial direction.

A tread in accordance with the present invention comprises a main portion comprising a first compound and a reinforcing structure comprising a second compound having reinforcing short fibers oriented between −20 degrees to +20 degrees to a circumferential direction of the tread. The main portion of the tread further comprises at least one circumferential groove separating circumferential ribs. Each circumferential groove has two sides and a base therebetween. The reinforcing structure comprises a layer of the second compound secured to the sides of each circumferential groove.

### DEFINITIONS

“Apex” or “bead filler apex” means an elastomeric filler located radially above the bead core and between the plies and the turnup plies.

“Axial” and “Axially” mean the lines or directions that are parallel to the axis of rotation of the tire.

“Bead” or “Bead Core” generally means that part of the tire comprising an annular tensile member of radially inner beads that are associated with holding the tire to the rim; the beads being wrapped by ply cords and shaped, with or without other reinforcement elements such as flippers, chippers, apexes or fillers, toe guards and chafers.

“Carcass” means the tire structure apart from the belt structure, tread, undertread over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” most often means circular lines or directions extending along the perimeter of the surface of the annular tread perpendicular to the axial direction; it can also refer to the direction of the sets of adjacent circular curves whose radii define the axial curvature of the tread, as viewed in cross section.

“Cord” means one of the reinforcement strands, including fibers, with which the plies and belts are reinforced.

“Equatorial Plane” means the plane perpendicular to the tire's axis of rotation and passing through the center of its tread; or the plane containing the circumferential centerline of the tread.

“Flipper” refers to a reinforcing fabric around the bead wire for strength and to tie the bead wire in the tire body.

“Gauge” refers generally to a measurement and specifically to thickness.

“Inner Liner” means the layer or layers of elastomer or other material that form the inside surface of a tubeless tire and that contain the inflating fluid within the tire.

“Lateral” means a direction parallel to the axial direction.

“Normal Load” means the specific design inflation pressure and load assigned by the appropriate standards organization for the service condition for the tire.

“Ply” means a cord-reinforced layer of rubber-coated radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Sidewall” means that portion of a tire between the tread and the bead.

“Toe guard” refers to the circumferentially deployed elastomeric rim-contacting portion of the tire axially inward of each bead.

“Tread width” means the arc length of the tread surface in the plane includes the axis of rotation of the tire.

“Turnup end” means the portion of a carcass ply that turns upward (i.e., radially outward) from the beads about which the ply is wrapped.

### BRIEF DESCRIPTION OF THE DRAWINGS

The structure, operation, and advantages of the invention will become more apparent upon contemplation of the following description taken in conjunction with the accompanying drawings, wherein:

FIG. 1 represents a schematic cross-sectional view of an example tire for use with the groove region of the present invention;

FIG. 2 represents a schematic detail cross-sectional view of another groove region for use with the example tire of FIG. 1;

FIG. 3 represents a schematic graph of stress vs. strain measured for one example composition at two temperatures;

FIG. 4 represents a schematic graph of stress vs. strain measured for two other example compositions; and

FIG. 5 represents a schematic graph of stress vs. strain measured for three other example compositions.

### DETAILED DESCRIPTION OF AN EXAMPLE EMBODIMENT

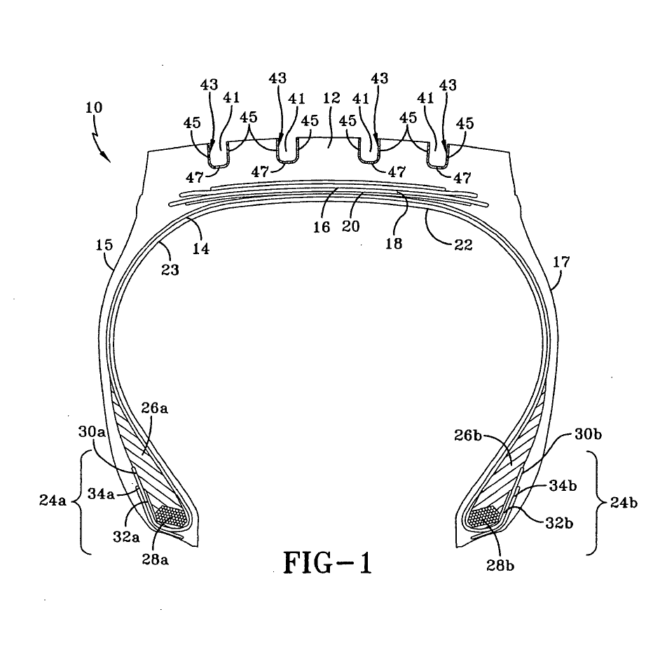

FIG. 1 shows an example tire 10 for use with groove reinforcing structures in accordance with the present invention. The example tire 10 has a tread 12, an inner liner 23, a belt structure 16 comprising belts 18, 20, a carcass 22 with a carcass ply 14, two sidewalls 15,17, and two bead regions 24a, 24b comprising bead filler apexes 26a, 26b and beads 28a, 28b. The example tire 10 is suitable, for example, for mounting on a rim of a passenger vehicle. The carcass ply 14 includes a pair of axially opposite end portions 30a, 30b, each of which is secured to a respective one of the beads 28a, 28b. Each axial end portion 30a or 30b of the carcass ply 14 is turned up and around the respective bead 28a, 28b to a position sufficient to anchor each axial end portion 30a, 30b.

The carcass ply 14 may be a rubberized ply having a plurality of substantially parallel carcass reinforcing members made of such material as polyester, rayon, or similar suitable organic polymeric compounds. The turned up portions of the carcass ply 14 may engage the axial outer surfaces of two flippers 32a, 32b and axial inner surfaces of two chippers 34a, 34b.

In accordance with the present invention, as shown in FIG. 1, the example tread 12 has four circumferential grooves 41, each having a lining comprising a U-shaped reinforcing structure 43. The main portion of the tread 12 may be formed of a first tread compound, which may be any suitable tread compound or compounds. Each reinforcing structure 43 occupies the inner surface of a circumferential groove 41 and is formed of a second compound stiffer than the first compound(s) of the main portion of the tread 12. The second compound includes reinforcing short fibers oriented between −20 degrees and +20 degrees to a circumferential direction of the tread 12 and the tire 10.

Each circumferential groove 41 is defined by a bottom or base laterally separating a pair of radially extending walls (U-shaped). As seen in FIG. 1, the reinforcing structure 43 completely lines each circumferential groove 41, in lateral, radial, and circumferential (not shown) directions. Each reinforcing structure 43 includes two radial portions 45, which form opposing walls of the reinforcing structure adjacent the radially extending walls of the circumferential grooves 41. Each reinforcing structure 43 further has a base portion 47 interconnecting the two radial portions 45 along the base of the circumferential grooves 41.

The radial portions 45 of the reinforcing structures 43 may extend radially outward fully to the ground contacting surface of the main portion of the tread 12. The radially outer ends of the radial portions 45 may wear away as the ground-contacting surface of the main portion of the tread 12 wears. One example reinforcing structure 43 may have a uniform thickness between 0.5 mm and 5.0 mm throughout the U-shaped structure.

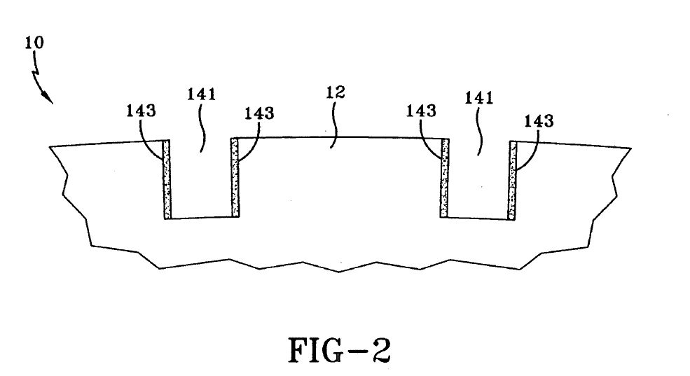

In accordance with another aspect of the present invention, as shown in FIG. 2, each example circumferential groove 141 may have a partial lining comprising a two reinforcing structures 143. The main portion of the tread 12 may be formed of a first tread compound, which may be any suitable tread compound, as described above with respect to FIG. 1. Each reinforcing structure 143 occupies part of the inner surface of a circumferential groove 141 and is formed of a second compound stiffer than the first compound of the main portion of the tread 12. The second compound includes reinforcing short fibers oriented between −20 degrees and +20 degrees to a circumferential direction of the tread 12 and the tire 10.

Each circumferential groove 141 is defined by a bottom or base laterally separating a pair of radially extending walls (U-shaped). As seen in FIG. 2, the reinforcing structures 143 line each wall of each circumferential groove 141, in radial and circumferential (not shown) directions. Each pair of reinforcing structures 143 form separate opposing walls of the circumferential grooves 141 adjacent the radially extending walls of the circumferential grooves. The pairs of reinforcing structures 143 in each circumferential groove 141 have no base portion or interconnection along the base of the circumferential grooves 41.

The reinforcing structures 143 may extend radially outward fully to the ground contacting surface of the main portion of the tread 12. The radially outer ends of the reinforcing structures 143 will wear away as the ground-contacting surface of the main portion of the tread 12 wears. Example reinforcing structures 143 may have a uniform thickness between 0.5 mm and 1.5 mm.

The specific composition and physical properties of the first compound of the tread 12 and the second compound of the reinforcing structures 43 or 143, and the relationships therebetween, will now be discussed. Modulus of elasticity E may measure, among other characteristics, the hardness of a particular compound. In general, the hardness of a homogeneous and uniform tread compound may be both beneficial and detrimental to various performance characteristics of a tire. For example, a harder tread compound may be beneficial in terms of tread wear rate and rolling resistance, when compared to a softer tread compound. However, the harder tread compound may be more susceptible to an edge effect and/or damage and have less wet traction than the softer tread compound.

Conversely, a softer tread compound may be less susceptible to the edge effect and/or damage and have greater wet traction than a harder tread compound. However, the softer tread compound may have a greater tread wear rate and higher rolling resistance than the harder tread compound. The reinforcing structures 43 in accordance with the present invention utilize a second harder and short-fiber reinforced tread compound to take advantage of the benefits of the harder and short-fiber reinforced tread compound in the area proximal to the circumferential grooves 41 and a softer tread compound for the remaining portion of the tread 12.

Specifically, the stiffer second short-fiber reinforced compound of the reinforcing structures 43 or 143 at the sides of the circumferential grooves 41 or 141 may limit the deformation of the first softer compound(s) of the adjacent tread ribs (i.e., “barrel” effect) thereby decreasing rolling resistance while sacrificing little, if any, tread wear and/or traction (wet or dry) characteristics. More specifically, the stiffer reinforcing structures 43 or 143 decrease groove/rib deformation thereby decreasing temperature build-up adjacent the grooves and decreasing rolling resistance.

Further, the short fibers of the reinforcing structures 43, 143 allow the second compound to be stiffer in the circumferential direction than the radially direction of the tread 12. Thus, the reinforcing structures 43, 143 in accordance with the present invention may decrease rolling resistance of a tire without the structures by as much as 8%.

One example second compound for use as the above reinforcing structures 43 or 143 may be a composition comprising from 5 to 40 parts per weight, per 100 parts by weight of rubber, of chopped, or chopped and fibrillated, aramid fibers having a length ranging from 0.1 to 10 mm and having a thickness ranging from 5 microns to 30 microns. Polyester, polyketone, polybenzobisoxazole (PBO), nylon, rayon, and/or other suitable organic and/or textile fibers may alternatively be used in the second compound.

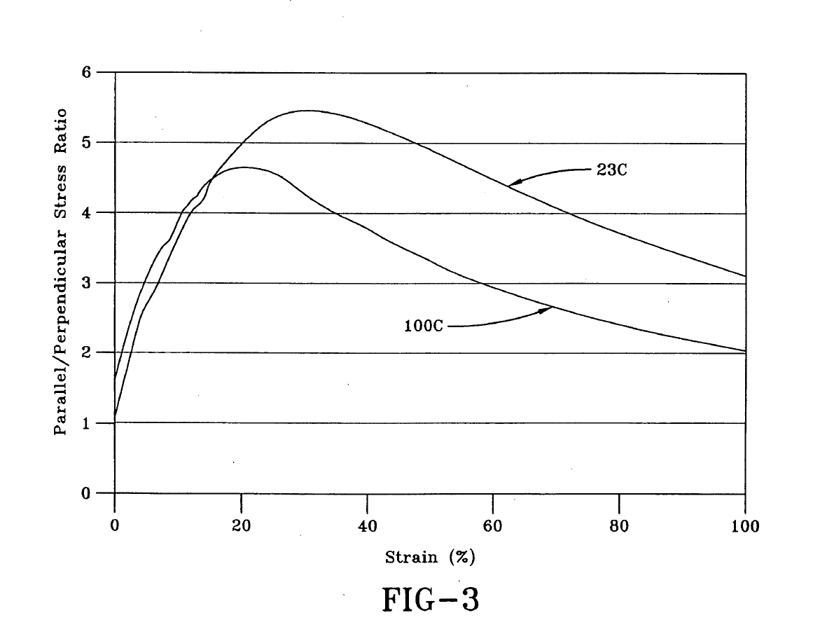

A sample of the above example second compound having 7.5 parts per weight, per 100 parts by weight of rubber, of chopped fibrillated aramid fibers having a length ranging from 0.1 to 10 mm and having a thickness ranging from 5 microns to 30 microns was milled into a sheet and cut into tensile test specimens. Tensile test specimens were cut in two orientations, one with the test pulling direction parallel with the milling direction of the specimen, and one with the test pulling direction perpendicular with the milling direction of the specimen. In this way, the effect of fiber orientation (generally in the direction of milling) and thus the anisotropy of the second compound was measured. The tensile samples were then measured for stress at various strains. A stress ratio, defined as the (stress measured in the direction parallel to the milling direction)/(stress measured in the direction perpendicular to the milling direction) was then calculated for each strain. The results of the stress ratio versus strain for temperatures of 23 degrees C. and 100 degrees C. are shown in FIG. 3.

Another example second compound for use as the above described reinforcing structures 43 or 143 may be a rubber composition comprising a diene based elastomer and from 5 to 40 parts by weight, per 100 parts by weight of elastomer, of short aramid fibers having a length ranging from 0.1 to 10 mm and having a thickness ranging from 5 microns to 30 microns. The short aramid fibers may have disposed on at least part of their surface a composition comprising: an aliphatic fatty acid or synthetic microcrystalline wax; a Bunte salt; a polysulfide comprising the moiety —[S]ₙ or —[S]ₒ—Zn—[S]ₚ, wherein each of o and p is 1-5, o+p=n, and n=2-6; and sulfur or a sulfur donor.

The short aramid fibers may be fibrillated (i.e., roughened and partially torn) and provided in a batch with natural rubber. Other short fibers, having similar stiffness, anisotropy, and rubber adhesion, may also be used in accordance with the present invention. Further, the chopped or chopped and fibrillated fibers of the above specified dimensions may be blended with the rubber during compounding/mixing.

The aliphatic fatty acid or synthetic microcrystalline wax may be present in an amount ranging from 10 to 90 percent by weight, based on the weight of the short aramid fibers, the fatty acid or wax, the Bunte salt, and the polysulfide. The aliphatic fatty acid may be stearic acid. The synthetic microcrystalline wax may be polyethylene wax.

The Bunte salt may have the formula (H)ₘ—(R¹—S—SO₃⁻M⁺)M.xH₂O, wherein m is 1 or 2, m′ is 0 or 1, and m+m′=2; x is 0-3, M is selected from Na, K, Li, ½ Ca, ½ Mg, and ⅓ Al, and R¹ is selected from C1-C12 alkylene, C1-C12 alkoxylene, and C7-C12 aralkylene. The Bunte salt may be disodium hexamethylene-1,6-bis(thiosulfate) dihydrate. The amount of the Bunte salt may range from 0.25 to 25 weight percent, based on the weight of plain fibers.

The polysulfide may be selected from the group consisting of dicyclopentamethylene thiuram tetrasulfide, bis-3-triethoxysilylpropyl tetrasulfide, alkyl phenol polysulfide, zinc mercaptobenzothiazole, and 2-mercaptobenzothiazyl disulfide. The amount of the polysulfide may range from 0.01 to 15 weight percent, based on the weight of the plain fibers.

The sulfur may be powdered sulfur, precipitated sulfur, and/or insoluble sulfur. The sulfur donor may be tetramethylthiuram disulfide, tetraethylthiuram disulfide, tetrabutylthiuram disulfide, dipentamethylene thiuram hexasulfide, dipentamethylene thiuram tetrasulfide, dithiodimorpholine, and/or mixtures thereof. The amount of the sulfur or sulfur donor may range from 0.001 to 10 weight percent, based on the weight of the plain fibers.

The combination of the Bunte salt, the polysulfide, and the sulfur or sulfur donor may be present in an amount ranging from 0.5 to 40 percent by weight, based on the weight of the plain fibers. In one embodiment, the combination of the Bunte salt, the polysulfide, and the sulfur or sulfur donor is present in an amount ranging from 1 to 20 percent by weight, based on the weight of the plain fiber. In one embodiment, the combination of the Bunte salt, the polysulfide, and the sulfur or sulfur donor is present in an amount ranging from 2 to 8 percent by weight, based on the weight of the plain fiber.

The rubber composition may be used with rubbers or elastomers containing olefinic unsaturation. The phrases “rubber or elastomer containing olefinic unsaturation” or “diene based elastomer” are intended to include both natural rubber and its various raw and reclaim forms, as well as various synthetic rubbers. In this description, the terms “rubber” and “elastomer” may be used interchangeably, unless otherwise prescribed. The terms “rubber composition”, “compounded rubber”, and “rubber compound” are used interchangeably to refer to rubber which has been blended or mixed with various ingredients and materials and such terms as are well known to those having skill in the rubber mixing or rubber compounding art.

Representative synthetic polymers may be the homopolymerization products of butadiene and its homologues and derivatives, such as methylbutadiene, dimethylbutadiene, and pentadiene, as well as copolymers, such as those formed from butadiene or its homologues or derivatives with other unsaturated monomers. Among the latter may be acetylenes (i.e., vinyl acetylene), olefins (i.e., isobutylene, which copolymerizes with isoprene to form butyl rubber), vinyl compounds (i.e., acrylic acid or acrylonitrile, which polymerize with butadiene to form NBR), methacrylic acid, and styrene (which polymerizes with butadiene to form SBR), as well as vinyl esters and various unsaturated aldehydes, ketones and ethers, e.g., acrolein, methyl isopropenyl ketone, and vinylethyl ether.

Specific examples of synthetic rubbers may include neoprene (polychloroprene), polybutadiene (including cis-1,4-polybutadiene), polyisoprene (including cis-1,4-polyisoprene), butyl rubber, halobutyl rubber (such as chlorobutyl rubber or bromobutyl rubber), styrene/isoprene/butadiene rubber, copolymers of 1,3-butadiene or isoprene with monomers such as styrene, acrylonitrile and methyl methacrylate, as well as ethylene/propylene terpolymers, also known as ethylene/propylene/diene monomer (EPDM), and in particular, ethylene/propylene/dicyclopentadiene terpolymers. Additional examples of rubbers which may be used include alkoxy-silyl end functionalized solution polymerized polymers (SBR, PBR, IBR and SIBR), silicon-coupled and tin-coupled star-branched polymers.

The rubber composition may also include up to 70 phr of processing oil. Processing oil may be included in the rubber composition as extending oil typically used to extend elastomers. Processing oil may also be included in the rubber composition by addition of the oil directly during rubber compounding. The processing oil used may include both extending oil present in the elastomers, and process oil added during compounding. Suitable process oils include various oils as are known in the art, including aromatic, paraffinic, naphthenic, vegetable oils, and low PCA oils, such as MES, TDAE, SRAE and heavy naphthenic oils.

The rubber composition may further include from about 10 to about 150 phr of silica. Siliceous pigments which may be used in the rubber compound include conventional pyrogenic and precipitated siliceous pigments (silica). Such conventional silicas might be characterized, for example, by having a BET surface area, as measured using nitrogen gas. The BET surface area may be in the range of about 40 to about 600 square meters per gram. The conventional silica may also be characterized by having a dibutylphthalate (DBP) absorption value in a range of about 100 to about 400, alternatively about 150 to about 300.

The conventional silica might be expected to have an average ultimate particle size, for example, in the range of 0.01 micron to 0.05 micron, as determined by an electron microscope, although the silica particles may be even smaller, or possibly larger, in size. Various commercially available silicas may be used.

Commonly employed carbon blacks may be used as a conventional filler in an amount ranging from 10 to 150 phr. The carbon blacks may have iodine absorptions ranging from 9 to 145 g/kg and DBP number ranging from 34 to 150 cm³/100 g.

Other fillers may be used in the rubber composition including, but not limited to, particulate fillers including ultra high molecular weight polyethylene (UHMWPE), crosslinked particulate polymer gels, and plasticized starch composite filler. Such other fillers may be used in an amount ranging from 1 to 30 phr.

It may readily be understood by those having skill in the art that the rubber composition would be compounded by methods generally known in the rubber compounding art, such as mixing the various sulfur-vulcanizable constituent rubbers with various commonly used additive materials such as, for example, sulfur donors, curing aids, such as activators and retarders and processing additives, such as oils, resins including tackifying resins and plasticizers, fillers, pigments, fatty acid, zinc oxide, waxes, antioxidants and antiozonants and peptizing agents. As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. In one embodiment, the sulfur-vulcanizing agent is elemental sulfur. The sulfur-vulcanizing agent may be used in an amount ranging from 0.5 to 8 phr, alternatively with a range of from 1.5 to 6 phr. Typical amounts of tackifier resins, if used, comprise about 0.5 to about 10 phr, usually about 1 to about 5 phr. Typical amounts of processing aids comprise about 1 to about 50 phr. Typical amounts of antioxidants comprise about 1 to about 5 phr. Representative antioxidants may be, for example, diphenyl-p-phenylenediamine and others. Typical amounts of antiozonants comprise about 1 to 5 phr. Typical amounts of fatty acids, if used, which can include stearic acid comprise about 0.5 to about 3 phr. Typical amounts of zinc oxide comprise about 2 to about 5 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

Accelerators may be used to control the time and/or temperature required for vulcanization and to improve the properties of the vulcanizate. A single accelerator system may be used, i.e., primary accelerator. The primary accelerator(s) may be used in total amounts ranging from about 0.5 to about 4 phr. Combinations of a primary and a secondary accelerator may be used with the secondary accelerator being used in smaller amounts, such as from about 0.05 to about 3 phr, in order to activate and to improve the properties of the vulcanizate. Combinations of these accelerators may be expected to produce a synergistic effect on the final properties and are somewhat better than those produced by use of either accelerator alone.

In addition, delayed action accelerators may be used which are not affected by normal processing temperatures, but produce a satisfactory cure at ordinary vulcanization temperatures. Vulcanization retarders might also be used. Suitable types of accelerators that may be used are amines, disulfides, guanidines, thioureas, thiazoles, thiurams, sulfenamides, dithiocarbamates and xanthates.

The mixing of the rubber composition may be accomplished by methods known to those having skill in the rubber mixing art. The ingredients may be mixed in at least two stages, namely, at least one non-productive stage followed by a productive mix stage. The final curatives including sulfur-vulcanizing agents may be mixed in the final stage, which may be called the “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art.

The second rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions and the volume and nature of the components. For example, the thermomechanical working may be from 1 to 20 minutes.

The second rubber composition may be milled, calendared, and/or extruded to form the reinforcing structures 43 or 143. The reinforcing structures 43 or 143 will have the short fibers with an orientation in the direction of processing, that is, a substantial portion of the fibers will generally be oriented in a direction which is consistent with, and parallel to, the material flow direction in the processing equipment. The second rubber composition may have a degree of anisotropy, that is, a modulus measured in a direction consistent with the processing direction may be greater than that measured in a direction perpendicular to the processing direction.

As stated above, located within each circumferential groove 41 or 141 and extending in an essentially circumferential direction relative to the tread 12 are the reinforcing structures 43 or 143. The short fibers of the reinforcing structures 43 or 143 may be substantially oriented in the circumferential direction. By substantially oriented, it is meant that the second compound for the reinforcing structures 43 or 143 may comprise fibers oriented at an angle ranging from −20 degrees to +20 degrees with respect to the circumferential direction along the tread 12 of the tire 10.

The example pneumatic tire for use with the present invention may be a race tire, passenger tire, runflat tire, aircraft tire, agricultural, earthmover, off-the-road, medium truck tire, or any pneumatic or non-pneumatic tire. In one example, the tire is a passenger or truck tire. The tire may also be a radial ply tire or a bias ply tire.

Vulcanization of the example pneumatic tire may generally be carried out at conventional temperatures ranging from about 100° C. to 200° C. Any of the usual vulcanization processes may be used such as heating in a press or mold and/or heating with superheated steam or hot air. Such tires can be built, shaped, molded and cured by various methods which are known and are readily apparent to those having skill in such art.

A second compound in accordance with the present invention is further illustrated by the following non-limiting examples.

### EXAMPLE 1

In this example, the effect of adding a short fiber to the second compound for the reinforcing structures 43 or 143 according to the present invention is illustrated. Rubber compositions containing diene based elastomer, fillers, process aids, antidegradants, and curatives were prepared following recipes as shown in Table 1, with all amounts given in parts by weight per 100 parts by weight of base elastomer (phr). Sample 1 contained no short fiber and served as a control. Sample 2 included Sulfron® 3000 short fibers mixed as a masterbatch of the short fibers in natural rubber.

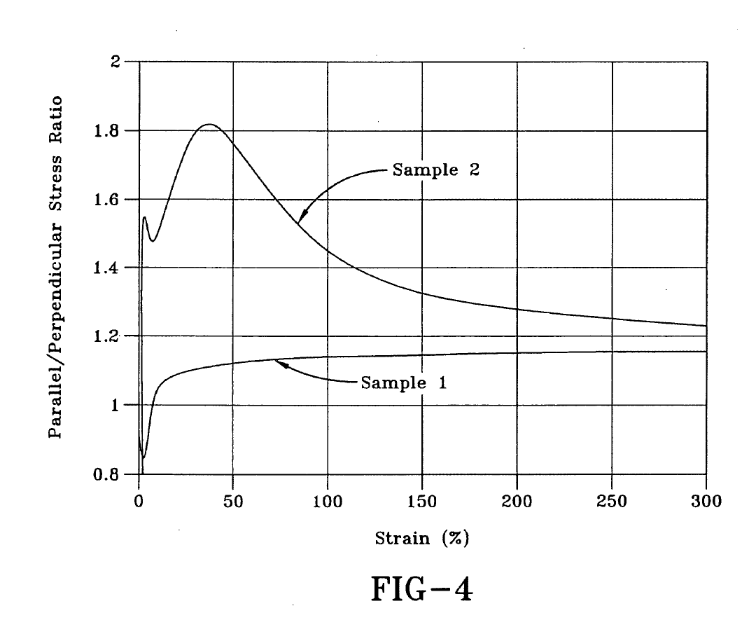

Rubber samples were milled into a sheet and cut into tensile test specimens. Tensile test specimens were cut in two orientations, one with the test pulling direction parallel with the milling direction of the specimen, and one with the test pulling direction perpendicular with the milling direction of the specimen. In this way, the effect of fiber orientation (generally in the direction of milling) and thus the anisotropy of the rubber composition was measured. The tensile samples were then measured for stress at various strains. A stress ratio, defined as the (stress measured in the direction parallel to the milling direction)/(stress measured in the direction perpendicular to the milling direction) was then calculated for each strain. The results of the stress ratio versus strain are shown in FIG. 4.

TABLE 1

Sample No.

| | |
|---|---|
| 1 | 2 |

Nonproductive Mix Stage

| | | |
|---|---|---|
| Natural Rubber | 100 | 100 |
| Carbon Black¹ | 57 | 50 |
| Resin² | 3.5 | 3.5 |
| Antioxidants³ | 4.25 | 4.25 |
| Paraffinic oil | 2 | 0 |
| Zinc Oxide | 8 | 8 |
| Stearic Acid | 2 | 0 |
| Silica⁴ | 8.6 | 8.6 |
| Short fibers⁵ | 0 | 15 |

Productive Mix Stage

| | | |
|---|---|---|
| HMMM⁶ | 4 | 4 |
| Accelerator⁷ | 1.05 | 1.05 |
| Insoluble sulfur | 5 | 5 |
| Retarder⁸ | 0.2 | 0.2 |

¹HAF type
²Phenol-formaldehyde type
³p-phenylene diamine and quinoline types
⁴surface area 125 m2/g
⁵Sulfron ® 3000, blend of 57.4% aramid short fibers (length 3 mm, diameter 12 microns) with 36.8% stearic acid and 5.8% treatment.
⁶Hexamethoxymethylmelamine (HMMM) on a silica carrier
⁷sulfenamide type
⁸phthalimide type

As seen in FIG. 4, the stress ratio for Sample 2 containing the short fibers shows a maximum at about 40 to 50 percent strain, indicating a strong anisotropic reinforcing effect of the fibers in the sample. Such anisotropy is important for applications such as the reinforcing structures 43 or 143 where anisotropic reinforcement is advantageous due to the directional stresses experienced by these tire tread components at low strains. By comparison, control Sample 1 with no fiber shows no such anisotropy.

### EXAMPLE 2

In this example, the effect of adding a short fiber to the second compound for the reinforcing structures 43 or 143 according to the present invention is illustrated. Rubber compositions containing diene based elastomer, fillers, process aids, antidegradants, and curatives were prepared following recipes, as shown in Table 1, with all amounts given in parts by weight per 100 parts by weight of base elastomer (phr). Sample 3 contained no short fiber and served as a control. Sample 4 included Sulfron® 3000 short fiber mixed as a masterbatch of the short fibers in natural rubber.

Sample 5 included a chopped short aramid fiber treated with nylon. As in Sample 2 and Sample 4, Sample 5 may be formed by mixing a chopped or a chopped and fibrillated short fiber masterbatch into the remaining natural rubber compound.

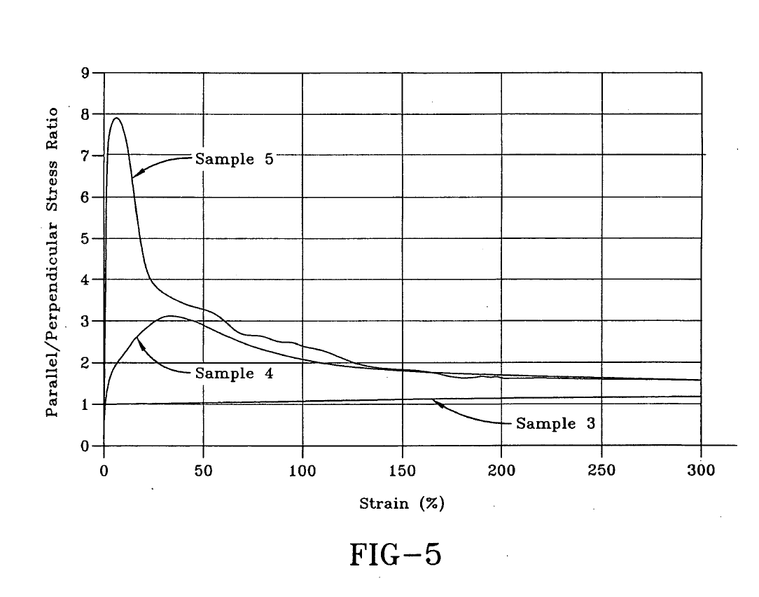

Rubber samples were milled into a sheet and cut into tensile test specimens. Tensile test specimens were cut in two orientations, one with the test pulling direction parallel with the milling direction of the specimen, and one with the test pulling direction perpendicular with the milling direction of the specimen. In this way, the effect of fiber orientation (generally in the direction of milling) and thus the anisotropy of the rubber composition was measured. The tensile samples were then measured for stress at various strains. A stress ratio, defined as the (stress measured in the direction parallel to the milling direction)/(stress measured in the direction perpendicular to the milling direction) was then calculated for each strain. The results of the stress ratio versus strain are shown in FIG. 5.

TABLE 2

| Sample No. | | |
|---|---|---|
| 3 | 4 | 5 |

Nonproductive Mix Stage

| | | | |
|---|---|---|---|
| Natural Rubber | 100 | 100 | 100 |
| Carbon Black¹ | 40 | 25 | 32.5 |
| Antioxidant² | 1 | 1 | 1 |
| Process Oil³ | 2 | 2 | 2 |
| Zinc Oxide | 5 | 5 | 5 |
| Stearic Acid | 0.5 | 0.5 | 0.5 |
| Short fiber⁴ | 0 | 20.2 | 0 |
| Short fiber⁵ | 0 | 0 | 10 |

Productive Mix Stage

| | | | |
|---|---|---|---|
| Antioxidants⁶ | 2.5 | 2.5 | 2.5 |
| Insoluble sulfur | 1.75 | 1.75 | 1.75 |
| Accelerator⁷ | 1.35 | 1.35 | 1.35 |

¹ASTM N-347
²quinoline type
³Low polycyclic aromatic (PCA) type
⁴Sulfron 3000, blend of 57.4% aramid short fibers (length 3 mm, diameter 12 microns) with 36.8% stearic acid and 5.8% treatment.
⁵Nylon coated aramid short fibers
⁶p-phenylene diamine types
⁷sulfenamide type

As seen in FIG. 5, the stress ratio for Samples 4 and 5 containing the short fibers shows a maximum at low strain, indicating a strong anisotropic reinforcing effect of the fibers in these samples. However, Sample 5, containing the treated aramid short fibers shows a peak at higher strain with a much broader yield as compared with Sample 4, wherein a sharp yield is observed at a lower strain. Such behavior indicates that Sample 5 demonstrates superior adhesion of the short fibers to the rubber matrix, as illustrated by the broad yield peak at relatively higher strain. By contrast, the sharp yield at relatively lower strain for Sample 4 demonstrates much poorer adhesion by fibers in Sample 4.

Such anisotropy, as demonstrated by Sample 5, may be desirable for applications such as the second compound for the reinforcing structures 43 or 143 where anisotropic reinforcement along with good fiber adhesion is advantageous due to the directional stresses experienced by these tire tread components at low strains. The superior adhesion and broad yield at low strain for the Sample 5, as compared to Sample 4, indicates that reinforcing structures 43 or 143 of the composition of Sample 5 may be superior to structures 43 or 143 of the composition of Sample 4.

Typically, short fibers show behavior demonstrated by Sample 4, with a sharp yield at low strain, indicating poor adhesion and consequent inability to utilize any anisotropy in the compound at strains that may be incurred by the reinforcing structures 43 or 143. By contrast, Sample 5 shows much superior adhesion and a broad yield at higher strain, indicating that the composition of Sample 5 may better perform in the reinforcing structures 43 or 143. By further comparison, control Sample 3, with no fibers, shows no such anisotropy. An example of the rubber composition of Sample 5 may have a stress ratio greater than 1.5 at 30%-50% percent strain. Another example of the composition of Sample 5 may have a stress ratio greater than 2 at 30%-50% percent strain.

Applicant understands that the invention does not merely apply to new tires. For example, Applicant recognizes that the present invention can be applied to tread layers used with retreaded tires and to tire tread layers in strip form which are ultimately cured before or after mounting on a tire casing. Applicant also recognizes that the present invention is not limited to commercial vehicle tires. For example, automobile tires can benefit from the present invention.

The above description is given in reference to example embodiments of a tire having a tread portion for reducing rolling resistance and increasing fuel economy. However, it is understood that many variations are apparent to one of ordinary skill in the art from a reading of the disclosure of the invention. Such variations and modifications apparent to those skilled in the art are within the scope and spirit of the instant invention, as defined by the following appended claims.

Further, variations in the present invention are possible in light of the descriptions of it provided herein. While certain representative example embodiments and details have been shown for the purpose of illustrating the subject invention, it will be apparent to those skilled in this art that various changes and modifications can be made therein without departing from the scope of the subject invention. It is, therefore, to be understood that changes may be made in the particular example embodiments described which will be within the fully intended scope of the invention as defined by the following appended claims.

What is claimed is:

1. A tire having an axis of rotation, the tire comprising:
two sidewalls extending radially outward; and
a tread disposed radially outward of the two sidewalls and interconnecting the two sidewalls, the tread comprising a main portion comprising a first compound and a reinforcing structure comprising a second compound having reinforcing short fibers oriented between −20 degrees to +20 degrees to a circumferential direction of the tread,
the main portion of the tread comprising at least one circumferential groove separating circumferential ribs, each circumferential groove having two sides and a base therebetween, the reinforcing structure comprising a layer of the second compound secured to the sides of each circumferential groove.

2. The tire as set forth in claim 1 wherein the tire is a pneumatic tire.

3. The tire as set forth in claim 1 wherein the tire is a non-pneumatic tire.

4. The tire as set forth in claim 1 further including a carcass ply radially inward of the tread.

5. The tire as set forth in claim 1 wherein the base and the two sides of the at least one circumferential groove define a U-shape.

6. The tire as set forth in claim 5 wherein the reinforcing structure is secured to the sides and the base of the at least one circumferential groove to define a U-shaped reinforcing structure.

7. The tire as set forth in claim 1 wherein the layer has a thickness between 0.5 mm and 1.5 mm.

8. The tire as set forth in claim 1 wherein the short fibers of the reinforcing structure are aramid short fibers.

9. The tire as set forth in claim 1 wherein the short fibers of the second compound have lengths ranging from 0.1 mm to 10 mm and thicknesses ranging from 5 microns to 30 microns.

10. The tire as set forth in claim 1 wherein the reinforcing structure comprises a pair of separate structures secured to only the sides of the at least one circumferential groove.

11. The tire as set forth in claim 1 wherein the reinforcing structure extends radially outward to a ground-contacting surface of the tread.

12. The tire as set forth in claim 1 wherein the second compound is stiffer than the first compound.

13. The tire as set forth in claim 1 wherein the second compound is stiffer in a circumferential direction than in the radial direction.

14. A tread for a tire comprising:
a main portion comprising a first compound and a reinforcing structure comprising a second compound having reinforcing short fibers oriented between −20 degrees to +20 degrees to a circumferential direction of the tread,
the main portion of the tread further comprising at least one circumferential groove separating circumferential ribs, each circumferential groove having two sides and a base therebetween, the reinforcing structure comprising a layer of the second compound secured to the sides of each circumferential groove.
